(19) United States
(12) Patent Application Publication
(10) Pub. No.: US 2026/0281522 A1
(43) Pub. Date: Sep. 17, 2026

(54) IMAGING SYSTEM AND IMAGING METHOD

(71) Applicant: Panasonic Intellectual Property Management Co., Ltd., Osaka (JP)

(72) Inventor: MOTOKI YAKO, Osaka (JP)

(21) Appl. No.: 19/676,914

(22) Filed: May 14, 2026

Related U.S. Application Data
(63) Continuation of application No. PCT/JP2025/008633, filed on Mar. 7, 2025.

(30) Foreign Application Priority Data
Mar. 13, 2024 (JP) 2024-039004

(51) Int. Cl. H04N 23/11; H04N 23/73; H04N 23/83

(52) U.S. Cl. CPC H04N 23/11; H04N 23/73; H04N 23/83

(57) ABSTRACT

An imaging system includes a camera that acquires a compressed image in which information regarding four or more wavelength bands is compressed, and a control circuit that sets an exposure time of the camera in an automatic exposure mode to acquire the compressed image using the camera. The automatic exposure mode includes a first mode for a case where images corresponding to four or more wavelength bands are to be generated based on the compressed image.

### BACKGROUND

### 1. Technical Field

The present disclosure relates to an imaging system and an imaging method.

### 2. Description of the Related Art

Compressed sensing is a technique that reconstructs more data than observed data by assuming that the distribution of observation target data is sparse in a certain space, such as frequency space. Compressed sensing can be applied, for example, to an imaging device that reconstructs an image including more information from a small amount of observation data. An imaging device to which compressed sensing is applied generates reconstructed images through arithmetic operations from an image in which the spectral information of a target has been compressed. As a result, various effects on images can be obtained such as higher resolution, wavelength expansion, shorter imaging time, or higher sensitivity.

U.S. Pat. No. 9,599,511 discloses an example of applying compressed sensing technology to a hyperspectral camera that acquires images in wavelength bands, each having a narrow bandwidth. According to the technology disclosed in U.S. Pat. No. 9,599,511, it is possible to realize a hyperspectral camera that generates high-resolution and multi-wavelength images.

### SUMMARY

One non-limiting and exemplary embodiment provides an imaging system that is capable of appropriately setting parameters, such as exposure time, gamma correction value, or both, in acquisition, processing, or acquisition and processing of an image in which spectral information is compressed.

In one general aspect, the techniques disclosed here feature an imaging system including a camera that acquires a compressed image in which information regarding four or more wavelength bands is compressed, and a control circuit that sets an exposure time of the camera in an automatic exposure mode to acquire the compressed image using the camera. The automatic exposure mode includes a first mode for a case where four or more images corresponding to four or more respective wavelength bands are to be generated based on the compressed image.

General or specific embodiments of the present disclosure may be implemented as a system, an apparatus, a method, an integrated circuit, a computer program, a computer-readable recording medium, such as a recording disc, or any selective combination thereof. Examples of the computer-readable recording medium include a nonvolatile recording medium such as a compact disc read-only memory (CD-ROM). The apparatus may be constituted by one or more devices. In a case where the apparatus is constituted by two or more devices, the two or more devices may be disposed in a single apparatus or may be distributed among two or more separate apparatuses. In this specification and the claims, an “apparatus” may refer not only to a single apparatus but also to a system constituted by apparatuses.

With the technology according to the present disclosure, an imaging device can be realized that is capable of setting parameters, such as exposure time, gamma correction value, or both to acquire, process, or acquire and process an image in which spectral information is compressed.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram schematically illustrating an example of the configuration of an imaging system;

FIG. 1B is a diagram schematically illustrating another example of the configuration of the imaging system;

FIG. 1C is a diagram schematically illustrating yet another example of the configuration of the imaging system;

FIG. 1D is a diagram schematically illustrating yet another example of the configuration of the imaging system;

FIG. 2A is a diagram schematically illustrating an example of a filter array;

FIG. 2B includes diagrams illustrating an example of a spatial distribution of optical transmittance of each of wavelength bands W₁, W₂, . . . , W_{N} included in a target wavelength range;

FIG. 2C is a diagram illustrating an example of the spectral transmittance of a region A1 included in the filter array illustrated in FIG. 2A;

FIG. 2D is a diagram illustrating an example of the spectral transmittance of a region A2 included in the filter array illustrated in FIG. 2A;

FIG. 3 is a diagram for describing the relationship between a target wavelength range W and wavelength bands W₁, W₂, . . . , W_{N} included in the target wavelength range W;

FIG. 4A is a diagram for describing characteristics of the spectral transmittance of a certain region of the filter array;

FIG. 4B is a diagram illustrating a result obtained by averaging, on a wavelength band basis, the spectral transmittance of each of the wavelength bands W₁, W₂, . . . , W_{N} illustrated in FIG. 4A;

FIG. 5 is a diagram illustrating a compressed image with unsaturated pixel values, a compressed image with saturated pixel values, and schematic distributions of pixel values in cross-sections taken along the horizontal direction of the two compressed images;

FIG. 6 is a graph illustrating, in a case where measured noise is superposed on a compressed image, the relationship between the pixel value of each pixel within the compressed image and the increase in reconstruction error at the corresponding pixel within a hyperspectral image;

FIG. 7 is a diagram schematically illustrating an example of the configuration of an imaging system according to the present embodiment that reduces the reconstruction error of a reconstructed image;

FIG. 8 is a flowchart schematically illustrating Example 1 of a control operation performed by a control circuit in an automatic exposure mode in a case where a compressed image is acquired;

FIG. 9 is a flowchart schematically illustrating an example of an operation of calculating a first exposure time, the operation being performed by the control circuit;

FIG. 10 is a flowchart schematically illustrating Example 1 of a processing operation performed by a processing circuit;

FIG. 11 is a flowchart schematically illustrating Example 2 of the control operation performed by the control circuit in the automatic exposure mode in a case where a compressed image is acquired;

FIG. 12 is a flowchart schematically illustrating an example of an operation of calculating a second exposure time, an operation of adjusting the ISO sensitivity, or both performed by the control circuit;

FIG. 13 is a flowchart schematically illustrating Example 2 of a processing operation performed by the processing circuit;

FIG. 14 is a diagram schematically illustrating a graphical user interface (GUI) example displayed on a display device; and

FIG. 15 is a diagram for describing reconstruction error in a reconstructed image when γ correction is applied to a compressed image.

### DETAILED DESCRIPTIONS

In the present disclosure, all or one or more of circuits, units, devices, members, or portions or all or one or more of the functional blocks of a block diagram may be executed by, for example, one or more electronic circuits including a semiconductor device, a semiconductor integrated circuit (IC), or a large scale integration circuit (LSI). The LSI or the IC may be integrated on one chip or may be formed by combining chips. For example, functional blocks other than a storage device may be integrated on one chip. In this case, the term LSI or IC is used; however, the term(s) to be used may change depending on the degree of integration, and the term such as system LSI, very large scale integration (VLSI), or ultra large scale integration (ULSI) may be used. A field programmable gate array (FPGA) or a reconfigurable logic device that allows reconfiguration of interconnection inside the LSI or setup of a circuit section inside the LSI can also be used for the same purpose, the FPGA and the reconfigurable logic device being programmed after the LSI is manufactured.

Furthermore, functions or operations of all or one or more of the circuits, the units, the devices, the members, or the portions can be executed through software processing. In this case, the software is recorded in one or more non-transitory recording media, such as a read-only memory (ROM), an optical disc, or a hard disk drive, and when the software is executed by a processing device (a processor), the function specified by the software is executed by the processing device (the processor) and its peripheral devices. The system or the apparatus may include the one or more non-transitory recording media in which the software is recorded, the processing device (the processor), and a hardware device to be needed, such as an interface.

In the present disclosure, “light” refers not only to visible light (wavelengths from about 400 nm to about 700 nm) but also to electromagnetic waves including ultraviolet rays (wavelengths from about 10 nm to about 400 nm) and infrared rays (wavelengths from about 700 nm to about 1 mm).

In the following, examples of embodiments of the present disclosure will be described. Note that any one of the embodiments described below is intended to represent a general or specific example. The numerical values, shapes, constituent elements, arrangement positions and connection forms of the constituent elements, steps, and the order of steps are examples and are not intended to limit the present disclosure. Among the constituent elements of the following embodiments, the constituent elements that are not described in independent claims representing the most generic concept will be described as optional constituent elements. Each diagram is a schematic diagram and is not necessarily precisely illustrated. Furthermore, in each diagram, substantially the same or similar constituent elements are denoted by the same reference signs. Redundant description may be omitted or simplified.

Before describing the embodiments of the present disclosure, some of the findings underlying the present disclosure will be described.

The process of classifying targets in an image by type in the field of imaging is used in fields such as factory automation (FA) and medicine. Examples of features used in the classification process include spectral information regarding the targets as well as the shapes of the targets. Since hyperspectral cameras can acquire multi-wavelength images that contain abundant spectral information per pixel, it is expected that hyperspectral cameras will be utilized in the future. While research and development of hyperspectral cameras has been conducted worldwide for many years, their use has been limited for the following reasons. For example, line-scan hyperspectral cameras provide high spatial and wavelength resolution but take longer to capture images due to line scanning. Snapshot hyperspectral cameras can capture images in a single shot but often lack sufficient sensitivity and spatial resolution.

In contrast to them, it has recently been reported that the sensitivity and spatial resolution of hyperspectral cameras can be improved by reconstructing images on the basis of sparsity. Sparsity is the property that the elements characterizing an observation target are present in a certain space, such as frequency space, in a sparse manner. Sparsity is widely observed in the natural world. The use of sparsity allows necessary information to be observed efficiently. Sparsity-based sensing technology is called compressed sensing technology. Compressed sensing technology can be used to construct highly efficient devices and systems.

As a specific application example of compressed sensing technology, a hyperspectral camera with improved wavelength resolution has been proposed, as disclosed in U.S. Pat. No. 9,599,511, for example. Such a hyperspectral camera is equipped, for example, with an optical filter that has irregular optical transmission characteristics with respect to space, wavelength, or both. Such an optical filter is also referred to as an “encoding mask”. An encoding mask is disposed along an optical path of light incident on an image sensor and transmits the incident light from a target so as to have region-dependent optical transmission characteristics. This process performed by the encoding mask is referred to as “encoding”. The spectral information regarding the target is compressed in an image of the target acquired through the encoding mask. The image is referred to as a “compressed image”. Mask information indicating the optical transmittance of the encoding mask is stored in advance as a reconstruction table in a memory device.

An image processing apparatus performs a reconstruction process on the basis of the compressed image and the reconstruction table. Through the reconstruction process, more information than that in the compressed image can be obtained. Examples of the information include higher resolution image information or image information covering more wavelengths. The reconstruction table may be, for example, data indicating the spatial distribution of the optical response characteristics of the encoding mask. Through the reconstruction process based on such a reconstruction table, reconstructed images can be generated, which correspond to the respective wavelength bands included in a target wavelength range, from a single compressed image. In the following description, “reconstructed images” are also simply referred to as “reconstructed images”.

In compressed sensing technology, in a case where a compressed image is not suitable for the reconstruction process, reconstruction error in a reconstructed image increases. An example of a compressed image that is not suitable for the reconstruction process is that the pixel values of some pixels included in the compressed image are saturated. This is because the pixel values of some pixels are constant when saturated, and thus information necessary for the reconstruction operation is lost. The pixel values corresponding to the pixels included in the compressed image increase as the exposure time of the image sensor increases or the ISO sensitivity of the image sensor increases.

In the automatic exposure mode of existing cameras, priority is given to images suitable for user viewing, and the parameters related to exposure (for example, exposure time, ISO sensitivity, or both) are adjusted so that the average pixel value is, for example, 40% of the saturation value, referring to the average pixel value of such an image. This can cause the pixel values of some pixels to saturate.

Japanese Unexamined Patent Application Publication No. 2005-62370 discloses a method for adjusting the exposure time or ISO sensitivity of an imaging device depending on the scene, such as sports photography, landscape photography, and portrait photography. Even with that imaging device, it is considered that priority is given to images suitable for user viewing, and the pixel values of some pixels can be saturated. Thus, applying the method disclosed in Japanese Unexamined Patent Application Publication No. 2005-62370 to compressed sensing technology does not reduce reconstruction error in a reconstructed image.

As in the above-mentioned examples, the present inventor found a problem arising from the fact that parameters, such as exposure time, are not properly set to acquire, process, or acquire and process a compressed image, and arrived at an imaging system according to an embodiment of the present disclosure that is capable of solving the problem. In the imaging system according to the present embodiment, for example, the exposure time is appropriately set in the automatic exposure mode such that the highest pixel value among the pixel values corresponding to respective pixels included in a compressed image is sufficiently high without causing saturation. As a result, reconstruction error in a reconstructed image can be reduced.

Note that correction of pixel values by adjusting ISO sensitivity does not contribute to improvement of reconstruction accuracy because noise is amplified along with pixel values.

### EMBODIMENTS

In the following, first, an imaging system that generates reconstructed images on the basis of compressed images will be described. Next, a method for reducing reconstruction error in a reconstructed image even in a case where a compressed image is acquired in an automatic exposure mode will be described.

### 1. Imaging System

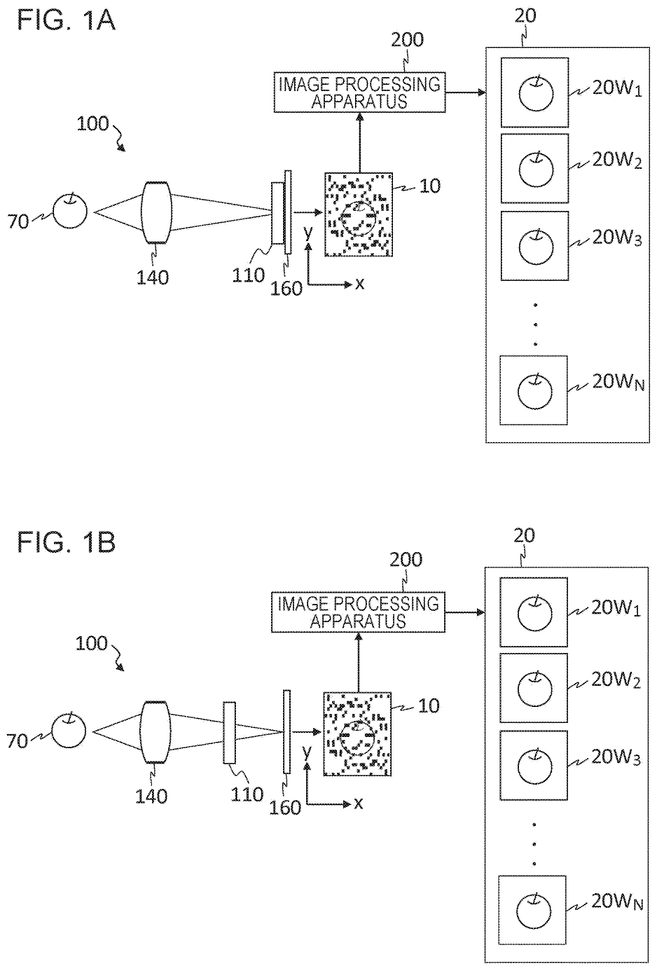

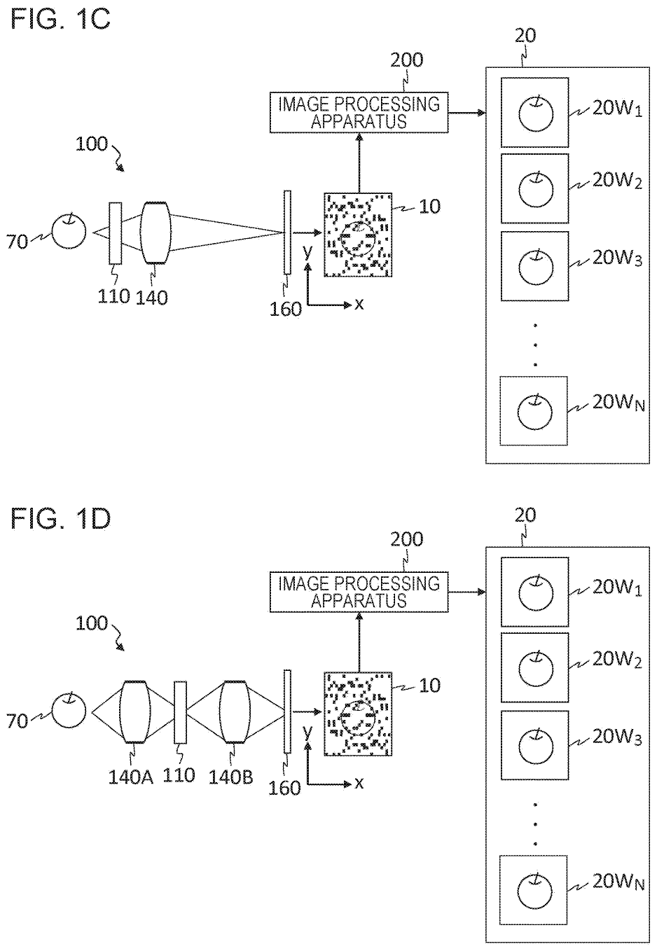

FIG. 1A is a diagram schematically illustrating an example of the configuration of an imaging system. The system illustrated in FIG. 1A includes an imaging device 100 and an image processing apparatus 200. The imaging device 100 has substantially the same configuration as the imaging device disclosed in U.S. Pat. No. 9,599,511. The imaging device 100 includes an optical system 140, a filter array 110, and an image sensor 160. The optical system 140 and the filter array 110 are disposed along an optical path of incident light from a target 70, which is a subject. The filter array 110 in the example illustrated in FIG. 1A is disposed between the optical system 140 and the image sensor 160.

FIG. 1A illustrates an apple as an example of the target 70. The target 70 is not limited to an apple, and may be any object. The image sensor 160 generates data of a compressed image 10, which is obtained by compressing information regarding wavelength bands into a two-dimensional monochrome image. The image processing apparatus 200 generates data representing images that correspond one-to-one to wavelength bands included in a predetermined target wavelength range, on the basis of the data of the compressed image 10 generated by the image sensor 160. In this case, suppose that the number of wavelength bands included in the target wavelength range is N (N is an integer greater than or equal to 4). In the following description, N images generated on the basis of the compressed image 10 are referred to as reconstructed images 20W₁, 20W₂, . . . , 20W_{N}, and these images may also be referred to collectively as a “hyperspectral image 20”.

The filter array 110 in the present embodiment is an array of filters arranged in rows and columns and having translucency. The filters include different kinds of filters having different spectral transmittances from each other, that is, having different wavelength-dependent optical transmittances from each other. The filter array 110 modulates the intensity of incident light for each wavelength and outputs the resulting light. This process performed by the filter array 110 will be referred to as “encoding”, and the filter array 110 will be also referred to as an “encoding mask”. Alternatively, the filter array 110 is also simply referred to as an “optical filter”.

In the example illustrated in FIG. 1A, the filter array 110 is disposed near or directly on the image sensor 160. In this case, “near” refers to the filter array 110 being close enough to the image sensor 160 that an image of light from the optical system 140 is formed on the surface of the filter array 110 in a state where the image of light has a certain degree of clearness. “Directly on” refers to the filter array 110 and the image sensor 160 being close to each other to an extent that there is hardly any gap therebetween. The filter array 110 and the image sensor 160 may be formed as a single device.

The optical system 140 includes at least one lens. In FIG. 1A, the optical system 140 is illustrated as one lens; however, the optical system 140 may be a combination of lenses. The optical system 140 forms an image on an imaging surface of the image sensor 160 through the filter array 110.

The filter array 110 may be disposed so as to be spaced apart from the image sensor 160. FIGS. 1B to 1D are diagrams illustrating examples of the configuration of the imaging device 100, in which the filter array 110 is arranged so as to be spaced apart from the image sensor 160. In the example illustrated in FIG. 1B, the filter array 110 is disposed between the optical system 140 and the image sensor 160 and at a position spaced apart from the image sensor 160. In the example illustrated in FIG. 1C, the filter array 110 is disposed between the target 70 and the optical system 140. In the example illustrated in FIG. 1D, the imaging device 100 includes two optical systems 140A and 140B, and the filter array 110 is disposed between the optical systems 140A and 140B. As in these examples, an optical system including one or more lenses may be disposed between the filter array 110 and the image sensor 160.

The image sensor 160 is a monochrome light detector having light detection devices (also referred to as “pixels” in this specification) arranged two-dimensionally. The image sensor 160 may be, for example, a charge-coupled device (CCD), a complementary metal oxide semiconductor (CMOS) sensor, or an infrared array sensor. The light detection devices include, for example, a photodiode. The image sensor 160 is not necessarily a monochrome sensor. For example, color sensors may be used. A color sensor may include, for example, red (R) filters transmitting red light, green (G) filters transmitting green light, and blue (B) filters transmitting blue light. The color sensor may further include IR filters that transmit infrared light. Moreover, a color sensor may include transparent filters that transmit all red, green, and blue light. The use of a color sensor can increase the amount of information regarding wavelengths and improve the reconstruction accuracy of the hyperspectral image 20. A wavelength region as an acquisition target may be freely determined. The wavelength region is not limited to the visible wavelength region and may also be the ultraviolet wavelength region, the near infrared wavelength region, the mid-infrared wavelength region, or the far-infrared wavelength region.

The image processing apparatus 200 may be a computer including one or more processors and one or more storage media, such as a memory. The image processing apparatus 200 generates data of reconstructed images 20W₁, 20W₂, . . . , 20W_{N} on the basis of the compressed image 10 acquired by the image sensor 160.

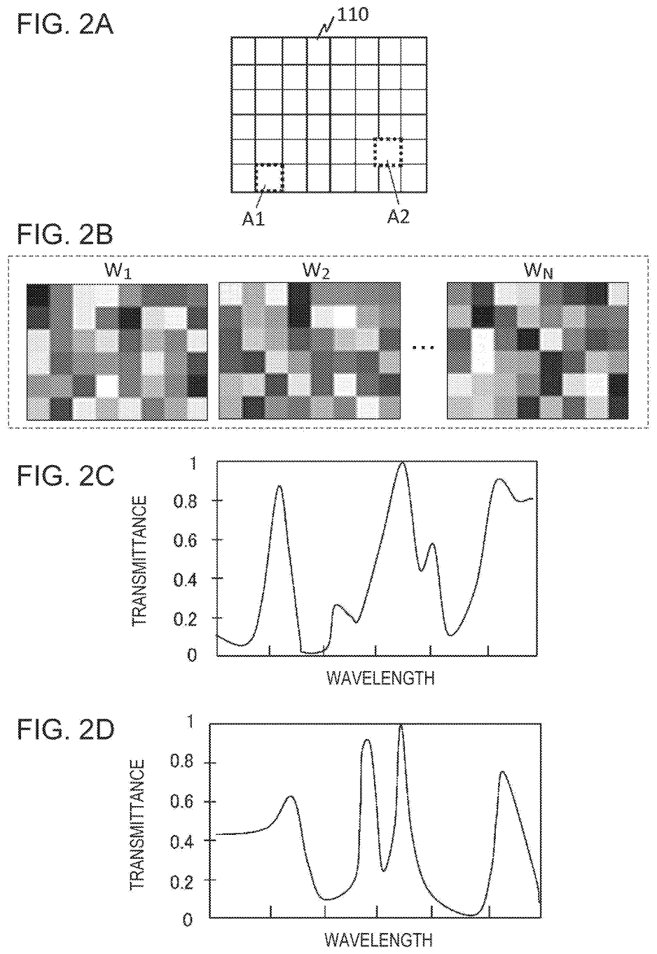

FIG. 2A is a diagram schematically illustrating an example of the filter array 110. The filter array 110 has regions arranged two-dimensionally. In this specification, these regions may be referred to as “cells”. In each region, a filter having a spectral transmittance set individually is disposed. Spectral transmittance is expressed by a function T(λ), where the wavelength of incident light is λ. The spectral transmittance T(λ) may have a value greater than or equal to 0 and less than or equal to 1.

In the example illustrated in FIG. 2A, the filter array 110 has 48 rectangular regions arranged in 6 rows and 8 columns. This is merely an example, and a larger number of regions than this may be provided in actual applications. The number of regions may be about the same as, for example, the number of pixels of the image sensor 160. The number of filters included in the filter array 110 is determined in accordance with the application, for example, within a range from several tens to several tens of millions.

FIG. 2B includes diagrams illustrating an example of a spatial distribution of optical transmittance of each of wavelength bands W₁, W₂, . . . , W_{N} included in the target wavelength range. In the example illustrated in FIG. 2B, differences in shading between the regions represent differences in transmittance. The lighter the shade of the region, the higher the transmittance. The darker the shade of the region, the lower the transmittance. As illustrated in FIG. 2B, the spatial distribution of optical transmittance differs depending on the wavelength band.

FIG. 2C is a diagram illustrating an example of the spectral transmittance of a region A1, and FIG. 2D is a diagram illustrating an example of the spectral transmittance of a region A2, the regions A1 and A2 being included in the filter array 110 illustrated in FIG. 2A. The spectral transmittance of the region A1 is different from that of the region A2. In this manner, the spectral transmittance of the filter array 110 varies depending on the region. Note that all the regions do not necessarily have different spectral transmittances from each other. At least some of the regions included in the filter array 110 have different spectral transmittances from each other. The filter array 110 includes two or more filters that have different spectral transmittances from each other. In one example, the number of patterns of spectral transmittances of the regions included in the filter array 110 may be the same as N, which is the number of wavelength bands included in the target wavelength range, or greater than or equal to N. The filter array 110 may be designed such that at least half of the regions have different spectral transmittances from each other.

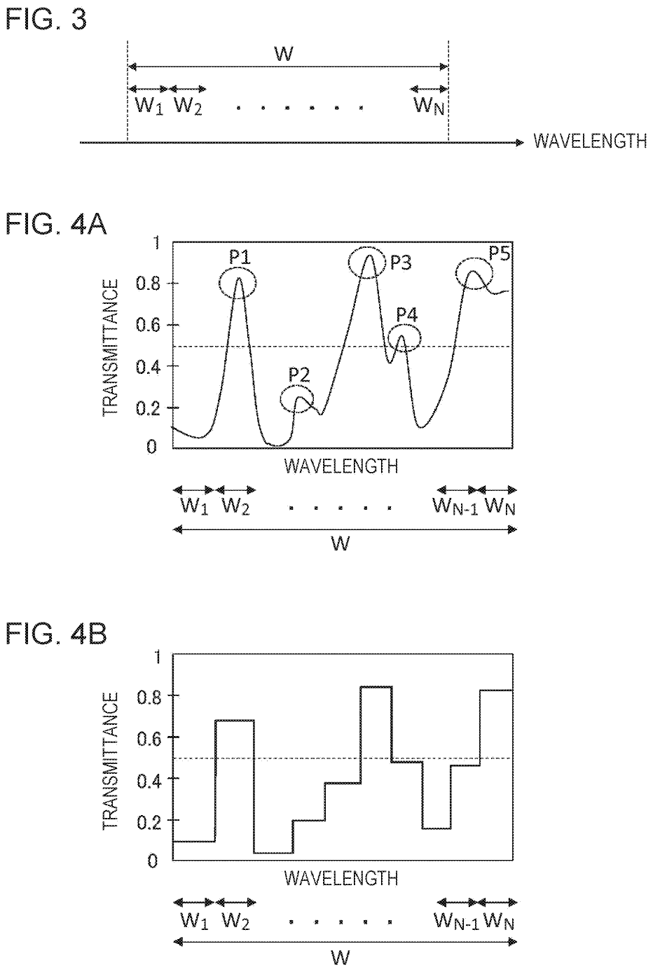

FIG. 3 is a diagram for describing the relationship between a target wavelength range W and wavelength bands W₁, W₂, . . . , W_{N} included in the target wavelength range W. The target wavelength range W may be set to various ranges depending on the application. The target wavelength range W may have, for example, a wavelength range of visible light of about 400 nm to about 700 nm, a wavelength range of near infrared rays of about 700 nm to about 2500 nm, or a wavelength range of near ultraviolet rays of about 10 nm to about 400 nm. Alternatively, the target wavelength range W may be a wavelength range of mid-infrared rays or a wavelength range of far-infrared rays. In this manner, the wavelength range to be used is not limited to the visible light range. In this specification, not only visible light but also radiation in general including infrared rays and ultraviolet rays will be referred to as “light”.

In the example illustrated in FIG. 3, N is set to any integer greater than or equal to 4, the target wavelength range W is equally divided into N sections, and the N wavelength ranges are referred to as the wavelength bands W₁, W₂, . . . , W_{N}. Note that the example is not limited to this one. The wavelength bands included in the target wavelength range W may be freely set. For example, the wavelength bands may have different bandwidths.

FIG. 4A is a diagram for describing characteristics of the spectral transmittance of a certain region of the filter array 110. In the example illustrated in FIG. 4A, regarding wavelengths within the target wavelength range W, the spectral transmittance has local maxima P1 to P5 and local minima. In the example illustrated in FIG. 4A, the optical transmittance within the target wavelength range W is normalized to have a maximum value of 1 and a minimum value of 0. In the example illustrated in FIG. 4A, the spectral transmittance has local maxima in the wavelength ranges of, for example, the wavelength band W₂ and the wavelength band W_{N-1}. In this manner, the spectral transmittance of each region may be designed to have local maxima in at least two of the wavelength ranges of the wavelength bands W₁, W₂, . . . , W_{N}. In the example illustrated in FIG. 4A, the local maxima P1, P3, P4, and P5 are greater than or equal to 0.5.

In this manner, the optical transmittance of each region varies with wavelength. Thus, the filter array 110 transmits a large amount of a certain wavelength range component of incident light but does not substantially transmit other wavelength range components of the incident light. For example, the transmittances of light in k wavelength bands among the N wavelength bands may be greater than 0.5, and the transmittances of light in the other N−k wavelength bands may be less than 0.5, where k is an integer that satisfies 2≤k<N. If incident light is white light, which includes all the visible light wavelength components equally, the filter array 110 modulates, on a region basis, the incident light into light having discrete peaks in intensity for wavelengths and superimposes and outputs light of these multiple wavelengths.

FIG. 4B is a diagram illustrating, as one example, a result obtained by averaging, on a wavelength band basis, the spectral transmittance of each of the wavelength bands W₁, W₂, . . . , W_{N} illustrated in FIG. 4A. The average transmittance is obtained by integrating the spectral transmittance T(λ) for each wavelength band and performing division using the bandwidth of the wavelength band. In this specification, the average transmittance value for each wavelength band obtained in this manner will be treated as the transmittance of the wavelength band. In this example, transmittance is prominently high in the three wavelength ranges corresponding to the local maxima P1, P3, and P5. In particular, transmittance is higher than 0.8 in the two wavelength ranges corresponding to the local maxima P3 and P5.

In the example illustrated in FIGS. 2A to 2D, a gray scale transmittance distribution is assumed in which the transmittance of each region may have any value greater than or equal to 0 and less than or equal to 1. However, a gray scale transmittance distribution is not always needed. For example, a binary scale transmittance distribution may be used in which the transmittance of each region may have either a value of approximately 0 or a value of approximately 1. In a binary scale transmittance distribution, each region transmits a large portion of light of at least two wavelength ranges among the wavelength ranges included in the target wavelength range, and does not transmit a large portion of light of the rest of the wavelength ranges. In this case, the “large portion” refers to about 80% or more.

Some cells among all the cells, for example, half of the cells, may be replaced with transparent regions. Such transparent regions transmit light of each of the wavelength bands W₁, W₂, . . . , W_{N} included in the target wavelength range W at a similarly high transmittance, for example, 80% or higher. With such a configuration, the transparent regions are arranged, for example, in a checkerboard manner. That is, the regions having optical transmittance that varies with wavelength and the transparent regions may be arranged in an alternating manner in two directions of the arrayed regions in the filter array 110.

Data representing such a spatial distribution of the spectral transmittance of the filter array 110 is acquired beforehand on the basis of design data or by performing actual measurement calibration, and is stored in a storage medium of the image processing apparatus 200. This data is used in arithmetic processing to be described later.

The filter array 110 may be formed using, for example, a multilayer film, an organic material, a diffraction grating structure, a metal-containing nanostructure, or a metasurface. In a case where a multilayer film is used, for example, a dielectric multilayer film or a multilayer film including a metal layer may be used. In this case, the cells are formed such that at least one of the thickness, material, and stacking order of each multilayer film differs from cell to cell. As a result, spectral characteristics that are different from cell to cell can be realized. By using a multilayer film, a sharp rising edge and a sharp falling edge can be realized for spectral transmittance. A configuration using organic material can be realized by causing different cells to contain different pigments or dyes or by causing different cells to have different stacks of layers of materials. A configuration using a diffraction grating structure can be realized by causing different cells to have diffraction structures with different diffraction pitches or different depths. A metal-containing nanostructure can be fabricated using plasmon effect spectroscopy. Metasurfaces can be fabricated by nanofabricating dielectric materials in sizes smaller than the wavelength of incident light. In that structure, the refractive index for the incident light is spatially modulated. Alternatively, the incident light may be encoded by directly processing pixels included in the image sensor 160 without using the filter array 110.

From the foregoing, it can be said that the imaging device 100 has light receiving regions having different optical response characteristics from each other. In a case where the imaging device 100 has the filter array 110 including filters and the filters have irregularly different optical transmission characteristics from each other, the light receiving regions can be realized by the image sensor 160 with the filter array 110, which is disposed near or directly on the image sensor 160. In this case, the optical response characteristics of the light receiving regions are each determined on the basis of the transmittance spectra of the filters included in the filter array 110.

Alternatively, in a case where the imaging device 100 does not have the filter array 110, the light receiving regions can be realized, for example, by the image sensor 160 in which pixels are directly processed to have irregularly different optical response characteristics from each other. In this case, the optical response characteristics of the light receiving regions are each determined on the basis of the optical response characteristics of the pixels included in the image sensor 160.

Each of the above-mentioned multilayer film, organic material, diffraction grating structure, metal-containing nanostructure, and metasurface can encode incident light if it has a configuration in which spectral transmittance is modulated to vary with position in a two-dimensional plane. Thus, the above-mentioned multilayer film, organic material, diffraction grating structure, metal-containing nanostructure, or metasurface does not have to have a configuration in which filters are arranged in an array.

Next, an example of signal processing performed by the image processing apparatus 200 will be described. The image processing apparatus 200 reconstructs a hyperspectral image 20, which is a multi-wavelength image, on the basis of the compressed image 10 output from the image sensor 160 and characteristics of a transmittance spatial distribution for each wavelength of the filter array 110. In this case, “multi-wavelength” refers to, for example, more wavelength ranges than 3-color wavelength ranges, which are RGB wavelength ranges, acquired by normal color cameras. The number of such wavelength ranges may be, for example, any number between 4 and about 100. The number of such wavelength ranges will be referred to as the “number of bands”. Depending on the application, the number of bands may exceed 100.

Data to be obtained is data of the hyperspectral image 20, and the data will be denoted by f. If the number of bands is N, f is data obtained by integrating data of N image bands f₁, f₂, . . . , f_{N}. In this case, suppose that the horizontal direction of the image is the x-direction, and the vertical direction of the image is the y-direction. When the number of pixels in the x-direction for the image data to be obtained is m, and the number of pixels in the y-direction for the image data to be obtained is n, each of the image data f₁, f₂, . . . , f_{N} has n×m pixel values. Thus, the data f is data having n×m×N elements. In contrast, data g of the compressed image 10 acquired through encoding and multiplexing performed by the filter array 110 has nxm elements. The data g can be expressed by Equation (1) below.

$$g = Hf = H [ \begin{matrix}{f}_{1} \\ {f}_{2} \\ ⋮ \\ {f}_{N}\end{matrix} ] \qquad ( 1 )$$

In Equation (1), f represents the data of the hyperspectral image expressed as a one-dimensional vector. Each of f₁, f₂, . . . , and f_{N} has n×m elements. Thus, the vector on the right side is strictly a one-dimensional vector having n×m×N rows and one column. The data g of the compressed image is calculated as a one-dimensional vector having n×m rows and one column. A matrix H represents a conversion in which individual components f₁, f₂, . . . , f_{N} of the vector f are encoded and intensity-modulated using encoding information that varies depending on the wavelength band, and are then added to one another. Thus, H denotes a matrix having n×m rows and n×m×N columns. Equation (1) can also be expressed as follows.

$$g = {( {pg}_{11} … {pg}_{1 m} … {pg}_{n 1} … {pg}_{nm} )}^{T} = {H ( {f}_{1} … {f}_{N} )}^{T}$$

where pgᵢⱼ denotes the pixel value in the i-th row and j-th column of the compressed image 10.

When the vector g and the matrix H are given, it seems that f can be calculated by solving an inverse problem of Equation (1). However, the number of elements n×m×N of the data f to be obtained is greater than the number of elements n×m of the acquired data g. This problem is thus an ill-posed problem, and the problem cannot be solved as is. Thus, the image processing apparatus 200 uses the sparsity of the images included in the data f and uses a compressed sensing method to obtain a solution. Specifically, the data f to be obtained is estimated by solving Equation (2) below.

$${f}^{′} = {arg min}_{f} \{ {‖ Hf - g ‖}_{2}^{2} + τΦ ( f ) \} \qquad ( 2 )$$

In this case, f′ denotes estimated data of the data f. The first term in the braces of the equation above represents a shift between an estimation result Hf and the acquired data g, which is a so-called residual term. In this case, the sum of squares is treated as the residual term; however, an absolute value, a root-sum-square value, or the like may be treated as the residual term. The second term in the braces is a regularization term or a stabilization term. Equation (2) means to obtain f that minimizes the sum of the first term and the second term. The function in the braces in Equation (2) is called an evaluation function. The image processing apparatus 200 can cause the solution to converge through a recursive iterative operation and can calculate f that minimizes the evaluation function as a final solution f′.

The first term in the braces of Equation (2) refers to an arithmetic operation for obtaining the sum of squares of the differences between the acquired data g and Hf, which is obtained by converting f in the estimation process using the matrix H. The second term ΦD(f) is a constraint for regularization of f and is a function that reflects sparse information regarding estimated data. This function has the effect of making the estimated data smooth and stable. The regularization term can be expressed using, for example, discrete cosine transformation (DCT), wavelet transform, Fourier transform, or total variation (TV) of f. For example, in a case where total variation is used, stabilized estimated data can be acquired in which the effect of noise of the data g, observation data, is suppressed. The sparsity of the target 70 in the space of each regularization term differs with the texture of the target 70. A regularization term for which the texture of the target 70 becomes sparser in the space of the regularization term may be selected. Alternatively, regularization terms may be included in the arithmetic operation. τ is a weighting factor. The greater the weighting factor τ, the greater the amount of reduction of redundant data, thereby increasing a compression rate. The smaller the weighting factor τ, the lower the convergence to the solution. The weighting factor τ is set to an appropriate value with which f is converged to a certain degree and is not compressed too much.

Note that, in the configurations illustrated in FIGS. 1B and 1C, images encoded by the filter array 110 are acquired in bokeh states on the imaging surface of the image sensor 160. Thus, the hyperspectral image 20 can be reconstructed by reflecting the bokeh information in the above-described matrix H, the bokeh information being stored in advance. In this case, the bokeh information is expressed by a point spread function (PSF). The PSF is a function that defines the degree of spread of a point image to its surrounding pixels. For example, in a case where a point image corresponding to one pixel on an image is spread to a region of k×k pixels around the pixel due to bokeh, the PSF can be defined as a group of factors, that is, a matrix indicating the effect on the pixel value of each pixel in the region. The effect of bokeh on an encoding pattern expressed by the PSF is reflected in the matrix H, so that the hyperspectral image 20 can be reconstructed. The filter array 110 may be disposed at any position; however, a position may be selected where the encoding pattern of the filter array 110 does not spread so much as to disappear.

Through the above-mentioned process, the hyperspectral image 20 can be reconstructed on the basis of the compressed image 10 acquired by the image sensor 160. Details of the method for reconstructing the hyperspectral image 20 are disclosed in U.S. Pat. No. 9,599,511.

### 2. Imaging System that Reduces Reconstruction Error of Reconstructed Image

### 2.1. Factors of Reconstruction Error

In a case where a compressed image 10 is acquired in the automatic exposure mode of an existing camera, the exposure time is adjusted with reference to the average pixel value of the compressed image 10 since priority is given to images suitable for user viewing. The exposure time is adjusted so that the average pixel value of the compressed image 10 is about 40% of the saturation value, for example. As a result, the pixel values of some pixels included in the compressed image 10 may be saturated.

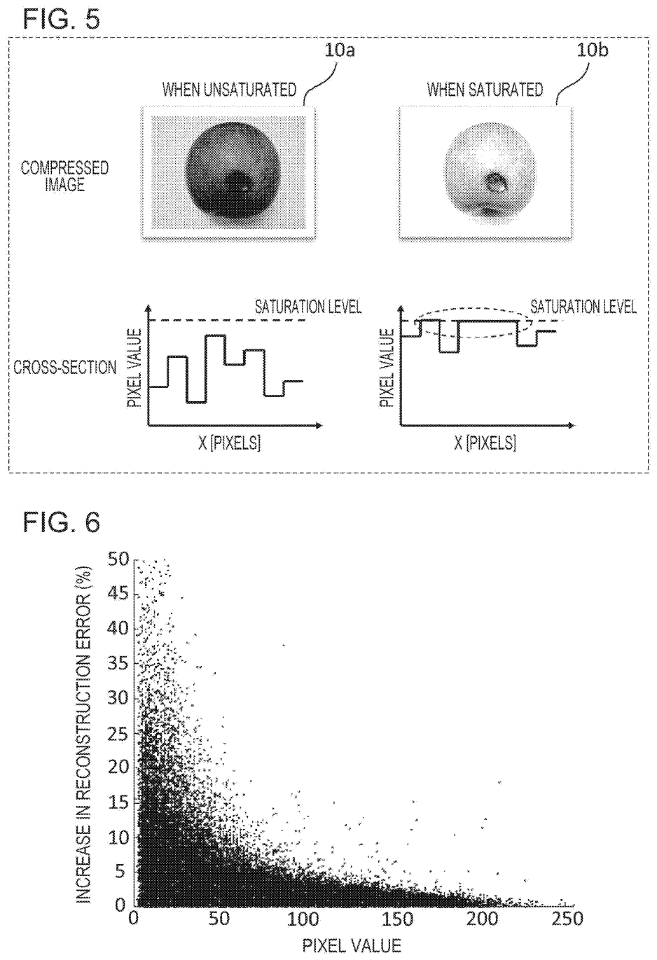

With reference to FIG. 5, the reason why the pixel values of some pixels included in the compressed image 10 become factors of reconstruction error will be described. FIG. 5 is a diagram illustrating a compressed image with unsaturated pixel values, a compressed image with saturated pixel values, and schematic distributions of pixel values in cross-sections taken along the horizontal direction of the two compressed images. In a compressed image 10a illustrated in FIG. 5, the pixel values of all pixels in a certain cross-section taken along the horizontal direction are lower than the saturation level represented by the dashed line, and the pixel values are unsaturated. In contrast, in a compressed image 10b illustrated in FIG. 5, the pixel values of some pixels in a certain cross-section taken along the horizontal direction have reached the saturation level, and those pixel values are saturated. The dashed ellipse illustrated in FIG. 5 represents areas where the pixel values are saturated. The pixel values of some pixels are constant when saturated. Thus, information necessary for the reconstruction operation is lost, resulting in an increase in reconstruction error in a reconstructed image.

### 2.2. Conditions for Reducing Increase in Reconstruction Error Due to Noise

Next, with reference to FIG. 6, conditions for reducing an increase in reconstruction error in a reconstructed image due to noise will be described. In practice, various noises can be superposed on a compressed image 10 such as read-out noise, optical shot noise, and fixed pattern noise. FIG. 6 is a graph illustrating, in a case where measured noise is superposed on a compressed image 10, the relationship between the pixel value of each pixel within the compressed image 10 and the increase in the reconstruction error of the corresponding pixel within a hyperspectral image 20. The target 70 is a white plate. In a case where the target wavelength range is the visible range, the white plate reflects light within the target wavelength range with substantially the same reflectance, regardless of the wavelength band. If the wavelength dependence of reflectance is low, the target 70 does not have to be a white plate.

The increase in reconstruction error at each pixel corresponds to the value obtained by subtracting a second reconstruction error for the case where noise is not superposed on the compressed image 10 from a first reconstruction error for the case where noise is superposed on the compressed image 10. The first reconstruction error is a reconstruction error at each pixel within the hyperspectral image 20 generated on the basis of the compressed image 10 on which noise is superposed. The second reconstruction error is a reconstruction error at the corresponding pixel within the hyperspectral image 20 generated on the basis of the compressed image 10 on which noise is not superposed. The reconstruction error at a certain pixel within the hyperspectral image 20 means the value obtained by averaging, for wavelength bands Wᵢ (i=1, . . . , N), the squared errors between the pixel value of a certain pixel within a reconstructed image 20Wᵢ and the pixel value of the corresponding pixel within its ground truth image.

The compressed image 10 includes 512×512 pixels arranged in a two-dimensional array. Pixel values are represented by 8-bit gradations. The compressed image 10 was acquired under conditions that resulted in an average luminance value of 128.

As illustrated in FIG. 6, the increase in reconstruction error increases steeply as the pixel value decreases, and the increase in reconstruction error decreases as the pixel value increases. In a case where the pixel value is greater than or equal to 153, that is, greater than or equal to 60% of the saturation value, which is 255, the increase in reconstruction error is less than or equal to 3%. In a case where the pixel value is greater than or equal to 178, that is, greater than or equal to 70% of the saturation value, the increase in reconstruction error is less than or equal to 2%. In a case where the pixel value is greater than or equal to 229, that is, greater than or equal to 90% of the saturation value, the increase in reconstruction error is less than or equal to 1%.

From the foregoing, as the overall pixel value of the compressed image 10 increases, the increase in reconstruction error due to noise can be suppressed. Note that this is the case where the pixel value is changed by adjusting the exposure time at a constant ISO sensitivity. If the pixel value is increased by increasing the ISO sensitivity instead of the exposure time, noise is amplified along with the pixel value, and thus the effect of improving reconstruction accuracy cannot be achieved.

Details of the conditions for reducing an increase in reconstruction error due to noise are disclosed in Japanese Patent Application No. 2022-209176 (filed on Dec. 27, 2022).

### 2.3. Configuration Example of Imaging System

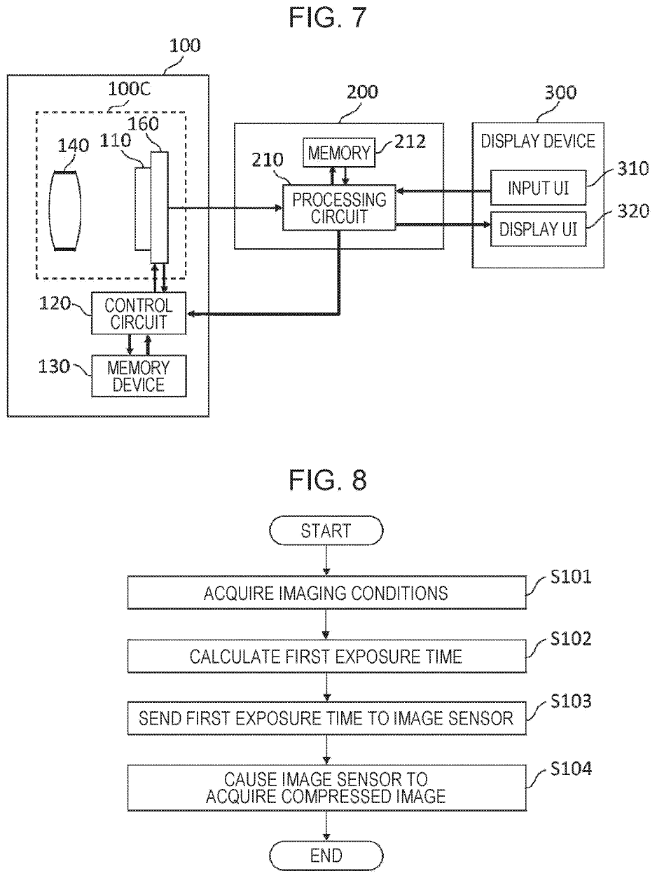

From 2.1 and 2.2 described above, reconstruction error in a reconstructed image can be reduced if a compressed image 10 has overall high pixel values within the range where the highest pixel value is not saturated. In the following, with reference to FIG. 7, an example of the configuration of an imaging system according to the present embodiment will be described that acquires such a compressed image 10 in an automatic exposure mode and reduces reconstruction error in a reconstructed image.

FIG. 7 is a diagram schematically illustrating a configuration example of an imaging system according to the present embodiment that reduces reconstruction error in a reconstructed image. The imaging system illustrated in FIG. 7 includes the imaging device 100, the image processing apparatus 200, and a display device 300.

The imaging device 100 includes a camera 100C, a control circuit 120, and a memory device 130. The camera 100C includes the filter array 110, the image sensor 160, and the optical system 140. In the present specification, a configuration including at least the filter array 110 and the image sensor 160 is referred to as a “camera”.

The camera 100C acquires a compressed image 10 of the target 70 in which information regarding four or more wavelength bands is compressed. The control circuit 120 controls the imaging operation of the camera 100C. The camera 100C may be read as the image sensor 160. The image sensor 160 detects light from the target 70 through the filter array 110.

The control circuit 120 sets the exposure time of the camera 100C in the automatic exposure mode. The exposure time in the automatic exposure mode is set each time a hyperspectral image 20, a compressed image 10 for generating an observation image described below, or both are acquired.

The memory device 130 includes one or more storage media. Each storage medium may be any storage medium, such as a semiconductor memory, a magnetic storage medium, or an optical storage medium, for example. The memory device 130 stores the exposure time set by the control circuit 120. The memory device 130 may further store the compressed image 10 acquired by the camera 100C.

The image processing apparatus 200 includes a processing circuit 210 and a memory 212. The processing circuit 210 controls the operation of the imaging device 100, and more specifically, the operation of the control circuit 120 included in the imaging device 100. Furthermore, the processing circuit 210 generates a hyperspectral image 20 on the basis of the compressed image 10 acquired by the camera 100C. The hyperspectral image 20 includes four or more reconstructed images corresponding to the four or more respective wavelength bands.

A computer program executed by the processing circuit 210 is stored in the memory 212, such as a read-only memory (ROM) or a random access memory (RAM). The processing circuit 210 and the memory 212 may be integrated on one circuit board or on separate circuit boards. The processing circuit 210 may also be distributed across circuits. The processing circuit 210, the memory 212, or both may be installed at a remote location or remote locations separate from the other constituent elements via a wired or wireless communication network.

Note that the control circuit 120 in the imaging device 100 and the processing circuit 210 in the image processing apparatus 200 may be integrated into one unit. The processing circuit obtained through the integration controls the imaging operation of the camera 100C and generates a hyperspectral image 20 on the basis of the compressed image 10.

The display device 300 displays an input user interface (UI) 310 and a display UI 320. The input UI 310 is used by the user to input information. The information input by the user into the input UI 310 is sent to the processing circuit 210 in the image processing apparatus 200. The information may be directly sent to the control circuit 120 in the imaging device 100. The display UI 320 displays information output from the processing circuit 210.

The input UI 310 and the display UI 320 are displayed as a graphical user interface (GUI). The information presented through the input UI 310 and the display UI 320 can also be said to be displayed by the display device 300. The input UI 310 and the display UI 320 may be realized by a device that allows both input and output, such as a touch screen. In such cases, the touch screen may function as the display device 300. In a case where a keyboard, a mouse, or both are used as the input UI 310, the input UI 310 is a device independent of the display device 300.

### 2.4. Example 1 of Control Operation Performed by Control Circuit

Next, Example 1 of a control operation will be described with reference to FIG. 8, the control operation being performed by the control circuit 120 in the imaging device 100 in the automatic exposure mode in a case where a compressed image 10 for generating a hyperspectral image 20 is to be acquired.

FIG. 8 is a flowchart schematically illustrating Example 1 of the control operation performed by the control circuit 120 in the automatic exposure mode in a case where a compressed image 10 is to be acquired. In Example 1 of the control operation, the automatic exposure mode includes the mode for generating a hyperspectral image 20. This mode is also referred to as a “first mode”. The control circuit 120 performs operations in Steps S101 to S104 illustrated in FIG. 8.

### Step S101

The control circuit 120 acquires imaging conditions. The imaging conditions can be, for example, the F-number and focus position of the optical system 140 and the ISO sensitivity of the image sensor 160. The focus position of the optical system 140 may be adjusted by autofocusing or by the user physically turning an adjustment ring of the optical system 140.

The control circuit 120 may acquire the imaging conditions input by the user into the input UI 310, via the processing circuit 210 or directly from the input UI 310, for example. Alternatively, the control circuit 120 may automatically read the imaging conditions from the camera 100C.

### Step S102

The control circuit 120 calculates a first exposure time. With an appropriate first exposure time, a compressed image 10 for generating a more accurate hyperspectral image 20 can be acquired. The operation of calculating the first exposure time will be described below.

### Step S103

The control circuit 120 sends the first exposure time mentioned above to the image sensor 160.

### Step S104

The control circuit 120 causes the image sensor 160 to acquire a compressed image 10 with the above-mentioned first exposure time. The control circuit 120 may further cause the image sensor 160 to send the compressed image 10 to the processing circuit 210 in the image processing apparatus 200 or cause the memory device 130 to store the compressed image 10. In this manner, the compressed image 10 can be sent to at least one of the processing circuit 210 or the memory device 130. When the compressed image 10 is sent to the processing circuit 210, a hyperspectral image 20 can be generated immediately after acquisition of the compressed image 10. When the compressed image 10 is sent to the memory device 130, a hyperspectral image 20 can be generated as necessary on the basis of the previously acquired compressed image 10.

Note that, in the camera 100C, γ correction for brightness and color adjustment does not have to be applied to the compressed image 10. That is, the γ correction value is 1. As described below, reconstruction error in a reconstructed image can be reduced if no γ correction is applied to the compressed image 10.

Note that, in the camera 100C, the application of γ correction to the compressed image 10 is not precluded. In a case where a compressed image 10 is acquired by the camera 100C using a γ correction value other than 1, the processing circuit 210 in the image processing apparatus 200 may generate a hyperspectral image 20 on the basis of the compressed image 10 corrected to have a γ correction value of 1.

For example, in a case where a compressed image 10 is acquired by the camera 100C using a correction value of γ=0.5, the processing circuit 210 generates a hyperspectral image 20 on the basis of the compressed image 10 corrected using γ=2. In a case where a compressed image 10 is acquired by the camera 100C using a correction value of γ=2.0, the processing circuit 210 generates a hyperspectral image 20 on the basis of the compressed image 10 corrected using γ=0.5.

Whether or not the control circuit 120 applies γ correction to the compressed image 10, the γ correction value is set constant regardless of the target 70. The γ correction value can be, for example, greater than or equal to 0.9 and less than or equal to 1.1, as described below. The compressed image 10 having such a γ correction value is sent to the memory device 130, as mentioned above. In that case, the compressed image 10 is stored in the memory device 130 in association with information regarding its own γ correction value. This helps the processing circuit 210 correct the compressed image 10 such that the γ correction value becomes 1. The information regarding the γ correction value may be information regarding the γ correction value itself or information from which the γ correction value can be derived.

The above-mentioned operation allows parameters, such as exposure time, gamma correction value, or both, to be set appropriately to acquire a compressed image 10. As a result, a compressed image 10 for generating a more accurate hyperspectral image 20 can be acquired.

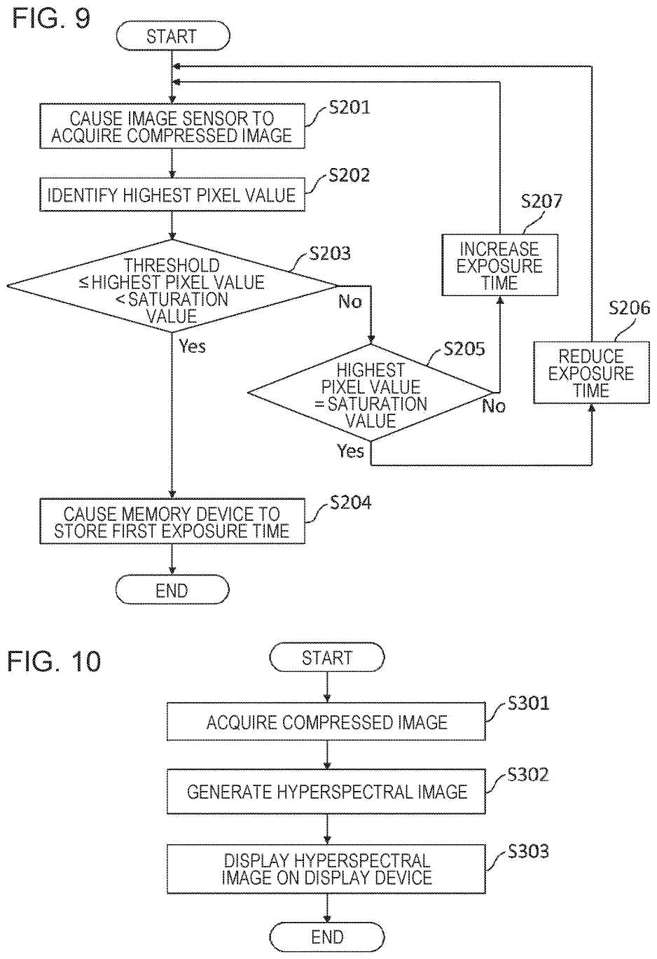

Next, with reference to FIG. 9, the operation of calculating the first exposure time in Step S102 illustrated in FIG. 8 will be described. FIG. 9 is a flowchart schematically illustrating an example of the operation of calculating the first exposure time, the operation being performed by the control circuit 120. In the first mode, the control circuit 120 sets the first exposure time on the basis of the highest pixel value among the pixel values corresponding to the respective pixels included in the compressed image 10. The control circuit 120 performs operations in Steps S201 to S207 illustrated in FIG. 9.

### Step S201

The control circuit 120 causes the image sensor 160 to acquire a compressed image 10 with a certain exposure time. The exposure time may depend on the imaging conditions or may be constant regardless of the imaging conditions. In a case where the memory device 130 stores a table indicating the correspondence between imaging conditions and exposure times, the control circuit 120 may select, as the above-mentioned exposure time, the exposure time corresponding to the imaging conditions closest to the acquired imaging conditions on the basis of the table.

### Step S202

The control circuit 120 identifies the highest pixel value among the pixel values corresponding to the respective pixels included in the compressed image 10.

### Step S203

The control circuit 120 determines whether or not the highest pixel value is greater than or equal to a predetermined threshold and lower than the saturation value. As mentioned above, as the overall pixel values of the compressed image 10 become higher within the range where the highest pixel value is not saturated, reconstruction error in a reconstructed image can be more effectively reduced. The saturation value varies with the color gradation. In a case where the gradation is 8 bits, the pixel value is an integer greater than or equal to 0 and less than or equal to 255, and thus the saturation value is 255. In a case where the gradation is 12 bits, the pixel value is an integer greater than or equal to 0 and less than or equal to 4095, and thus the saturation value is 4095.

The threshold will be described below. The threshold may be, for example, the value obtained by subtracting 1 from the saturation value. In this case, the highest pixel value is the highest in the unsaturated range. Note that the pixel value of each pixel in the compressed image 10 may fluctuate by about 2% of the saturation value due to noise. Considering this, the threshold may be, for example, the value that is 98% of the saturation value.

Alternatively, the threshold may be, for example, the value that is 90%, 70%, or 60% of the saturation value. In a case where the threshold is the value that is 90% of the saturation value, the increase in reconstruction error due to noise is less than or equal to 1%, as described with reference to FIG. 6. In a case where the threshold is the value that is 70% of the saturation value, the increase in reconstruction error due to noise is less than or equal to 2%. In a case where the threshold is the value that is 60% of the saturation value, the increase in reconstruction error due to noise is less than or equal to 3%.

In a case where a determination of Yes is obtained, the control circuit 120 performs the operation in Step S204. In a case where a determination of No is obtained, the control circuit 120 performs the operation in Step S205.

### Step S204

The control circuit 120 causes the memory device 130 to store, as the first exposure time, the exposure time used when the last compressed image 10 was acquired.

### Step S205

The control circuit 120 determines whether or not the highest pixel value is the same as the saturation value. In a case where a determination of Yes is obtained, the control circuit 120 performs the operation in Step S206. In a case where a determination of No is obtained, the control circuit 120 performs the operation in Step S207. In a case where a determination of No is obtained, the highest pixel value is lower than the predetermined threshold.

### Step S206

The control circuit 120 reduces the exposure time. Thereafter, the control circuit 120 performs the operation in Step S201 again.

### Step S207

The control circuit 120 increases the exposure time. Thereafter, the control circuit 120 performs the operation in Step S201 again.

Note that each time the control operation illustrated in FIG. 8 is performed, the first exposure time is recalculated. Thus, when the control operation illustrated in FIG. 8 is ended, the control circuit 120 may cause the memory device 130 to delete the first exposure time stored in Step S204.

Through the above-mentioned operation, the control circuit 120 can calculate the first exposure time suitable for the compressed image 10 for generating the hyperspectral image 20. As a result, the compressed image 10 having overall high pixel values within the range where the highest pixel value is not saturated can be obtained, and this can effectively reduce reconstruction error in a reconstructed image.

Next, with reference to FIG. 10, an example of a processing operation performed by the processing circuit 210 included in the image processing apparatus 200 will be described. FIG. 10 is a flowchart schematically illustrating Example 1 of the processing operation performed by the processing circuit 210. The processing circuit 210 performs operations in Steps S301 to S303 illustrated in FIG. 10.

### Step S301

The processing circuit 210 acquires a compressed image 10 from the camera 100C and more specifically from the image sensor 160 included in the camera 100C.

### Step S302

The processing circuit 210 generates a hyperspectral image 20 on the basis of the compressed image 10. The compressed image 10 may have, for example, a γ correction value that is greater than or equal to 0.9 and less than or equal to 1.1. In an example, the γ correction value may remain constant, unchanged, from acquisition of the compressed image 10 to generation of the hyperspectral image 20. In another example, in a case where γ correction is applied to the compressed image 10, the processing circuit 210 may generate a hyperspectral image 20 on the basis of the compressed image 10 corrected so as to have a γ correction value of 1.

The processing circuit 210 may determine whether or not the γ correction value for the compressed image 10 acquired from the camera 100C satisfies predetermined conditions. The predetermined conditions may include, for example, at least one of a γ correction value greater than or equal to 0.9 and less than or equal to 1.1, or a γ correction value of 1.0. The processing circuit 210 may acquire information regarding the γ correction value associated with the compressed image 10, for example, from the memory device 130 in the imaging device 100. The processing circuit 210 makes a determination on the basis of this information.

In a case where a determination of Yes is obtained, the processing circuit 210 generates a hyperspectral image 20 on the basis of the compressed image 10 acquired without changing the γ correction value. In a case where a determination of No is obtained, the processing circuit 210 changes the γ correction value for the compressed image 10 so that the predetermined conditions are satisfied, and generates a hyperspectral image 20 on the basis of the post-change compressed image 10.

In this manner, a parameter, such as gamma correction value, can be appropriately set to process the compressed image 10.

### Step S303

The processing circuit 210 displays the hyperspectral image 20 on the display UI 320 of the display device 300. Alternatively, the processing circuit 210 may display the analysis results based on the hyperspectral image 20 on the display UI 320 instead of or in addition to the hyperspectral image 20. Examples of such analysis include food inspection, biological testing, drug development, and mineral composition analysis.

Through the above-mentioned operation, the hyperspectral image 20, which is more accurate, can be displayed.

### 2.5. Example 2 of Control Operation Performed by Control Circuit

Depending on the type, state, or both of the target 70, the compressed image 10 may be output as an observation image without generating a hyperspectral image 20 on the basis of the compressed image 10. Alternatively, an observation image including three or fewer wavelength bands may be generated on the basis of the compressed image 10. The observation image including three or fewer wavelength bands may be, for example, an RGB color image or a monochrome image. In a case where the observation image is suitable for user viewing, the usability of the imaging system is improved.

In the following description, “generate an observation image on the basis of the compressed image 10” includes not only a case where an observation image including information regarding three or fewer wavelength bands is generated on the basis of the compressed image 10 but also a case where the compressed image 10 is output as an observation image, unless otherwise specified.

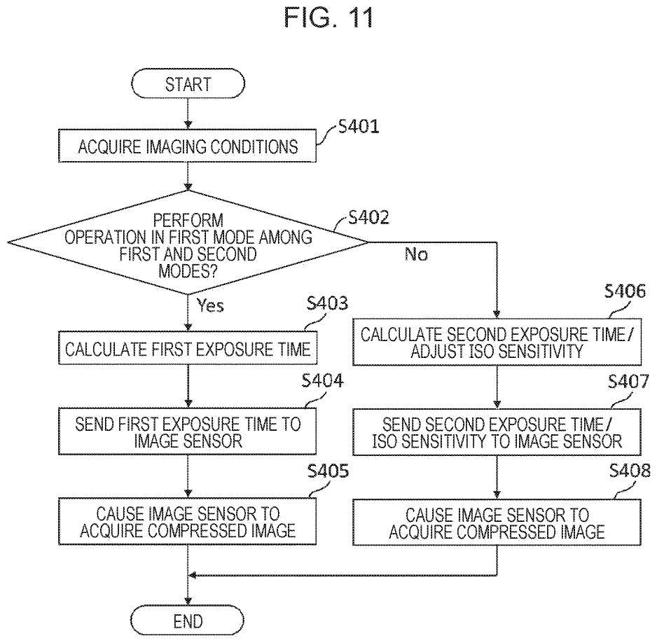

Next, Example 2 of the control operation will be described with reference to FIG. 11, the control operation being performed by the control circuit 120 included in the imaging device 100 in the automatic exposure mode in a case where a compressed image 10 for generating a hyperspectral image 20 or an observation image is to be acquired.

FIG. 11 is a flowchart schematically illustrating Example 2 of the control operation performed by the control circuit 120 in the automatic exposure mode in a case where a compressed image 10 is to be acquired. The automatic exposure mode further includes the first and second modes described below. The first mode is the mode for generating a hyperspectral image 20, as mentioned above. The second mode is the mode for generating an observation image. The control circuit 120 performs operations in Steps S401 to S408 illustrated in FIG. 11.

### Step S401

The operation in Step S401 is the same as that in Step S101 illustrated in FIG. 8.

### Step S402

The control circuit 120 determines whether or not to perform the operation in the first mode among the first and second modes. This determination may be made by the user through the input UI 310 or may be made automatically. For example, in a case where the number of wavelength bands is preset to 4 or more or a case where it is preset to generate a hyperspectral image 20, analyze the target 70, or do both, the control circuit 120 makes a determination of Yes automatically. In a case where the number of wavelength bands is preset to 3 or less or a case where it is preset to neither generate a hyperspectral image 20 nor analyze the target 70, the control circuit 120 makes a determination of No automatically.

In a case where a determination of Yes is obtained, the control circuit 120 performs the operations in Steps S403 to S405. In a case where a determination of No is obtained, the control circuit 120 performs the operations in Steps S406 to S408.

### Steps S403 to S405

The operations in Steps S403 to S405 are the same as those in Steps S102 to S104 illustrated in FIG. 8, respectively.

### Step S406

The control circuit 120 calculates a second exposure time, adjusts the ISO sensitivity, or do both. With an appropriate second exposure time, ISO sensitivity, or both, a compressed image 10 for generating an observation image suitable for user viewing can be acquired. The operation of calculating the second exposure time and the operation of adjusting the ISO sensitivity will be described below.

### Step S407

The control circuit 120 sends the above-mentioned second exposure time, the ISO sensitivity, or both to the image sensor 160.

### Step S408

The control circuit 120 causes the image sensor 160 to acquire a compressed image 10 with the above-mentioned second exposure time, the ISO sensitivity, or both. The control circuit 120 may further cause the image sensor 160 to send the compressed image 10 to the processing circuit 210 in the image processing apparatus 200 or cause the memory device 130 to store the compressed image 10. In this manner, the compressed image 10 can be sent to at least one of the processing circuit 210 or the memory device 130. When the compressed image 10 is sent to the processing circuit 210, an observation image can be generated immediately after acquisition of the compressed image 10. When the compressed image 10 is sent to the memory device 130, an observation image can be generated as necessary on the basis of the previously acquired compressed image 10.

Note that the compressed image 10 for generating an observation image is not as important as the compressed image 10 for generating a hyperspectral image mentioned above, and thus the control circuit 120 may delete the compressed image 10 without storing the compressed image 10 in the memory device 130. This helps save storage capacity of the memory device 130.

In the second mode, a compressed image 10 can be acquired with a different γ correction value from that for the compressed image 10 acquired in the first mode. When acquiring a compressed image 10, depending on the target 70, γ correction may be applied to the compressed image 10 such that the observation image is suitable for user viewing. The γ correction value may be determined depending on the target 70, for example, using any known method. When γ correction is applied, the γ correction value may be less than 1 or greater than 1.

Alternatively, the γ correction value may be set constant regardless of the target 70. The γ correction value may be, for example, less than or equal to 0.9 or greater than or equal to 1.1. The γ correction value may be determined, for example, on the basis of a histogram indicating the correspondence between pixel values and the numbers of pixels in the compressed image 10. The γ correction value may be determined, for example, on the basis of the average pixel value of the compressed image 10. The γ correction value may be set to any value by the user using the input UI 310, for example. For the γ correction value, for example, a default value may be prestored in the memory device 130, and the stored γ correction value may be used. The γ correction value may be less than or equal to 0.8 or less than or equal to 0.6. The γ correction value may be 0.44 to 0.46 (a value close to the reciprocal of 2.2).

The above-mentioned operation allows parameters, such as exposure time, gamma correction value, or both, to be set appropriately to acquire a compressed image 10. As a result, it is possible to acquire a compressed image 10 for generating a more accurate hyperspectral image 20, or a compressed image 10 for generating an observation image suitable for user viewing.

Note that both of the two compressed images 10 mentioned above may be acquired for the same target 70. In that case, for the same target 70, different exposure times, different ISO sensitivities, or different exposure times and ISO sensitivities are calculated.

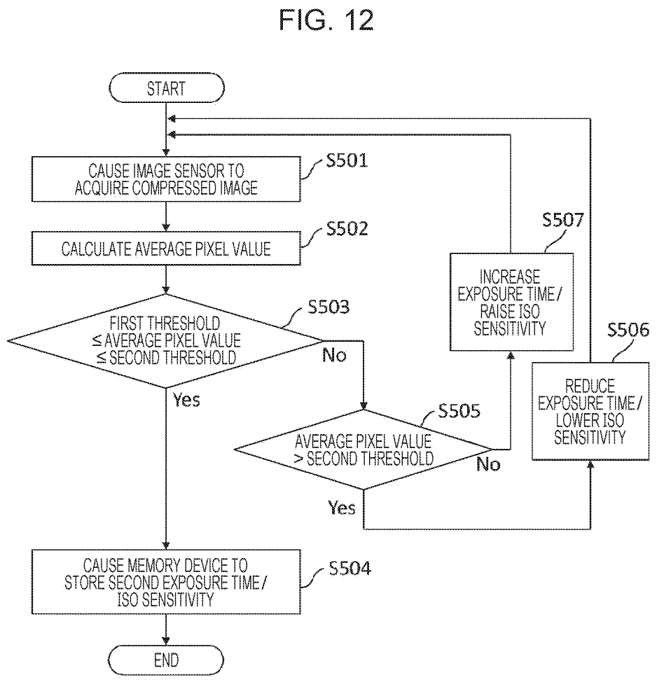

Next, with reference to FIG. 12, the operation of calculating the second exposure time, the operation of adjusting the ISO sensitivity, or both in Step S406 illustrated in FIG. 11 will be described. FIG. 12 is a flowchart schematically illustrating an example of the operation of calculating the second exposure time, the operation of adjusting the ISO sensitivity, or both performed by the control circuit 120. In the second mode, the control circuit 120 sets the second exposure time, the ISO sensitivity, or both on the basis of the average pixel value of the pixel values corresponding to the respective pixels included in the compressed image 10. The control circuit 120 performs operations in Steps S501 to S507 illustrated in FIG. 12.

### Step S501

The control circuit 120 causes the image sensor 160 to acquire a compressed image 10 with a certain exposure time, a given ISO sensitivity, or both. The exposure time, the ISO sensitivity, or both may depend on the imaging conditions or may be constant regardless of the imaging conditions. In a case where the memory device 130 stores a table indicating the correspondence between the imaging conditions and exposure times, between the imaging conditions and ISO sensitivities, or both of these correspondences, the control circuit 120 may use the table to select the exposure time, ISO sensitivity, or both corresponding to the imaging conditions closest to the acquired imaging conditions, as the above-mentioned exposure time, ISO sensitivity, or both.

### Step S502

The control circuit 120 calculates the average pixel value of the pixel values corresponding to the respective pixels included in the compressed image 10.

### Step S503

The control circuit 120 determines whether or not the average pixel value is greater than or equal to a predetermined first threshold and is less than or equal to a predetermined second threshold. The first and second thresholds may be set, for example, such that an observation image is suitable for user viewing. Since the average pixel value of an image suitable for user viewing is about 40% of the saturation value, the first threshold may be, for example, any value greater than or equal to 35% and less than 40%, and the second threshold may be, for example, any value greater than 40% and less than or equal to 45%. As an example, the first threshold and the second threshold are 38% and 42%, respectively. The first and second thresholds may be determined on the basis of the scene such as indoor and outdoor.

In a case where a determination of Yes is obtained, the control circuit 120 performs the operation in Step S504. In a case where a determination of No is obtained, the control circuit 120 performs the operation in Step S505.

### Step S504

The control circuit 120 causes the memory device 130 to store, as the second exposure time and the post-adjustment ISO sensitivity, the exposure time and ISO sensitivity used when the last compressed image 10 was acquired.

### Step S505

The control circuit 120 determines whether or not the average pixel value is higher than the second threshold. In a case where a determination of Yes is obtained, the control circuit 120 performs the operation in Step S506. In a case where a determination of No is obtained, the control circuit 120 performs the operation in Step S507. In a case where a determination of No is obtained, the average pixel value is lower than the first threshold.

### Step S506

The control circuit 120 reduces the exposure time, lowers the ISO sensitivity, or do both. Thereafter, the control circuit 120 performs the operation in Step S501 again.

### Step S507

The control circuit 120 increases the exposure time, raises the ISO sensitivity, or do both. Thereafter, the control circuit 120 performs the operation in Step S501 again.

Note that, in the control operation illustrated in FIG. 11, each time the operation for when a determination of No is obtained in Step S402 is performed, the second exposure time is recalculated, the ISO sensitivity is readjusted, or the second exposure time is recalculated and the ISO sensitivity is readjusted. Thus, when the control operation illustrated in FIG. 11 is ended, the control circuit 120 may cause the memory device 130 to delete the second exposure time, the post-adjustment ISO sensitivity, or both stored in Step S504.

Through the above-mentioned operation, the control circuit 120 can calculate the second exposure time suitable for a compressed image 10 for generating an observation image, adjust the ISO sensitivity so as to be suitable for the compressed image 10, or do both. As a result, the compressed image 10 in which the average pixel value is about 40% of the saturation value can be acquired, and it is possible to generate an observation image suitable for user viewing. Thus, the usability of the imaging system is improved.

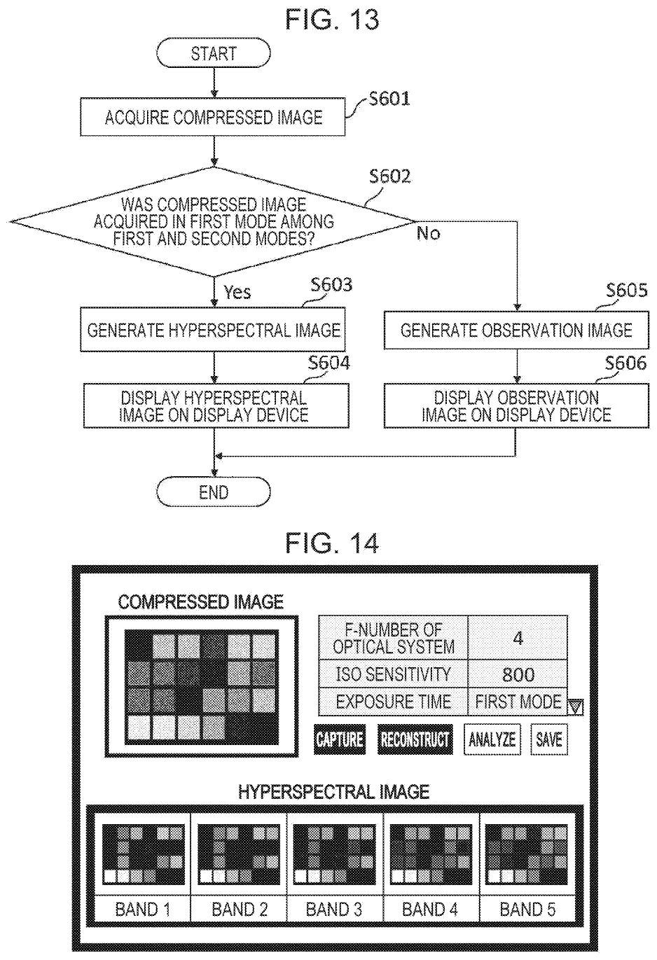

Next, with reference to FIG. 13, an example of a processing operation performed by the processing circuit 210 included in the image processing apparatus 200 will be described. FIG. 13 is a flowchart schematically illustrating Example 2 of the processing operation performed by the processing circuit 210. The processing circuit 210 performs operations in Steps S601 to S606 illustrated in FIG. 13.

### Step S601

The operation in Step S601 is the same as that in Step S301 illustrated in FIG. 10.

### Step S602

The processing circuit 210 determines whether or not the compressed image 10 was acquired in the first mode among the first and second modes. In a case where a determination of Yes is obtained, the processing circuit 210 performs the operations in Steps S603 to S604. In a case where a determination of No is obtained, the processing circuit 210 performs the operations in Steps S605 to S606.

### Steps S603 to S604

The operations in Steps S603 to S604 are the same as those in Steps S302 to S303 illustrated in FIG. 10, respectively.

### Step S605

The processing circuit 210 generates an observation image including information regarding three or fewer wavelength bands on the basis of the compressed image 10. In a case where the compressed image 10 is output as an observation image, Step S605 is omitted.

### Step S606

The processing circuit 210 displays the observation image on the display UI 320 of the display device 300.

Through the above-mentioned operation, the hyperspectral image 20, which is more accurate, or the observation image suitable for user viewing can be displayed.

### 2.6. GUI Displayed on Display Device 300

Next, a GUI example displayed on the display device 300 will be described with reference to FIG. 14. FIG. 14 is a diagram schematically illustrating a GUI example displayed on the display device 300.

The upper right part of the GUI illustrated in FIG. 14 displays fields for the user to input imaging conditions. In the fields, the F-number, the ISO sensitivity, and the exposure time of the optical system 140 are indicated. For the F-number and the ISO sensitivity of the optical system 140, the user may input numerical values. For the exposure time, the user may select either the first mode or the second mode displayed in a pull-down format.

On the GUI illustrated in FIG. 14, “capture”, “reconstruct”, “analyze”, and “save” buttons are displayed under the fields for the user to input imaging conditions. The “capture” button indicates display of a compressed image 10. The “reconstruct” button indicates display of a hyperspectral image 20. The “analyze” button indicates display of analysis results based on the hyperspectral image 20. The “save” button indicates saving the displayed compressed image 10, the displayed hyperspectral image 20, and the displayed analysis results. The compressed image 10 may be stored in the memory device 130 in the imaging device 100, for example. The hyperspectral image 20 and analysis results may be stored in the memory 212 in the image processing apparatus 200, for example.

In a case where the “capture” button is ON and the “reconstruct” and “analyze” buttons are OFF, the second mode may be automatically selected as exposure time. In a case where either the “reconstruct” button or the “analyze” button is ON, the first mode may be automatically selected as exposure time. In the example illustrated in FIG. 14, since the “reconstruct” button in ON, the first mode can be automatically selected as exposure time.

The upper left part of the GUI illustrated in FIG. 14 displays a compressed image 10. In a case where the first mode is selected, the compressed image 10 acquired with the first exposure time is displayed. In a case where the second mode is selected, the compressed image 10 acquired with the second exposure time is displayed.

The bottom part of the GUI illustrated in FIG. 14 displays the hyperspectral image 20. In a case where the first mode is selected, a hyperspectral image 20 is displayed. In a case where the second mode is selected, the bottom part of the GUI illustrated in FIG. 14 displays an observation image. In a case where the compressed image 10 is output as the observation image, since the compressed image 10 is already displayed on the upper left part of the GUI illustrated in FIG. 14, nothing needs to be displayed on the bottom part of the GUI illustrated in FIG. 14.

### 2.7. Reconstruction Error of Reconstructed Image when γ Correction is Applied to Compressed Image 10

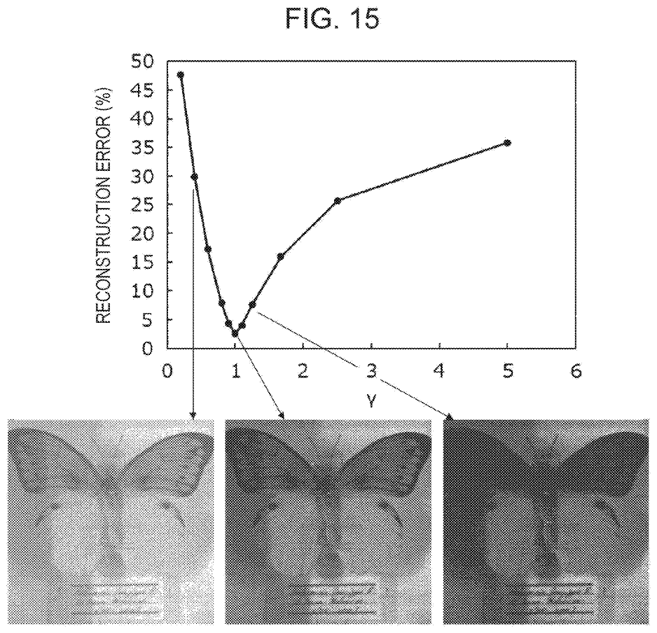

Next, with reference to FIG. 15, reconstruction error in a reconstructed image in a case where γ correction is applied to a compressed image 10 will be described. FIG. 15 is a diagram for describing reconstruction error in a reconstructed image when γ correction is applied to the compressed image 10. The vertical axis and the horizontal axis illustrated in FIG. 15 represent the reconstruction error of and γ correction value for the reconstructed image, respectively. As the reconstruction error of the reconstructed image, the mean squared error was used for the pixel values of the reconstructed image corresponding to a certain wavelength band and its ground truth image. γ correction values of 0.2, 0.4, 0.6, 0.8, 0.9, 1.0, 1.1, 1.25, 1.67, 2.5, and 5.0 were used. The compressed image 10 includes 512×512 pixels arranged in a two-dimensional array. The target 70 is a butterfly. The bottom left, center, and right views illustrated in FIG. 15 represent compressed images 10 at γ=0.4, 1.0, and 1.67, respectively. In a case where the γ correction value is less than 1, the compressed image 10 is brighter. In a case where the γ correction value is greater than 1, the compressed image 10 is darker.

As illustrated in FIG. 15, the reconstruction error is minimum at γ=1.0, and the reconstruction error increases as γ becomes away from 1.0. The reconstruction error is 2.55% at γ=1.0 and is less than or equal to 5% in the range of 0.9≤y≤1.1. As described above, reconstruction error in a reconstructed image can be reduced if no γ correction is applied to the compressed image 10.

From the foregoing, the imaging system according to the present embodiment allows parameters, such as exposure time, gamma correction value, or both, to be set appropriately to acquire, process, or acquire and process a compressed image 10.

In a case where the control circuit 120 sets the exposure time in the first mode included in the automatic exposure mode, a compressed image 10 for generating a more accurate hyperspectral image 20 can be acquired. Such a compressed image 10 can reduce reconstruction error in a reconstructed image.

Furthermore, in a case where the control circuit 120 sets the exposure time, the ISO sensitivity, or both in the second mode included in the automatic exposure mode, a compressed image 10 for generating an observation image suitable for user viewing can be acquired. With such a compressed image 10, an observation image suitable for user viewing can be generated, and the usability of the imaging system can be improved.

### 3. Appendix

The description of the above-mentioned embodiments discloses the following techniques.

### Technique 1

An imaging system includes
a camera that acquires a compressed image in which information regarding four or more wavelength bands is compressed, and
a control circuit that sets an exposure time of the camera in an automatic exposure mode to acquire the compressed image using the camera, and
the automatic exposure mode includes a first mode for a case where four or more images corresponding to four or more respective wavelength bands are to be generated based on the compressed image.

This imaging system allows parameters, such as exposure time, gamma correction value, or both, to be set appropriately to acquire, process, or acquire and process a compressed image. As a result, a compressed image for generating a more accurate hyperspectral image can be acquired.

### Technique 2

The imaging system according to Technique 1,
in which the automatic exposure mode further includes a second mode for a case where the compressed image is to be output as an observation image or a case where an observation image including information regarding three or fewer wavelength bands is to be generated based on the compressed image.

This imaging system can acquire a compressed image for generating an observation image suitable for user viewing.

### Technique 3

The imaging system according to Technique 1 or 2,
in which the compressed image acquired in the first mode is sent to a processing circuit, and
the processing circuit generates the four or more images based on the compressed image having a γ correction value greater than or equal to 0.9 and less than or equal to 1.1.

This imaging system can generate a more accurate hyperspectral image.

### Technique 4

The imaging system according to Technique 3, in which
the processing circuit
   determines whether or not the γ correction value for the compressed image acquired in the first mode and sent satisfies a predetermined condition,
   in a case where it is determined that the γ correction value for the compressed image does not satisfy the condition, changes the γ correction value for the compressed image to satisfy the predetermined condition, and
   generates the four or more images based on the compressed image obtained using the changed γ correction value, and the predetermined condition includes at least one of a γ correction value greater than or equal to 0.9 and less than or equal to 1.1, or a γ correction value of 1.0.

This imaging system can generate a more accurate hyperspectral image.

### Technique 5

The imaging system according to any one of Techniques 1 to 4, in which
the compressed image acquired in the first mode is acquired using a γ correction value greater than or equal to 0.9 and less than or equal to 1.1 and is sent to a memory device.

This imaging system can generate, as necessary, a more accurate hyperspectral image on the basis of the compressed image stored in the memory device.

### Technique 6

The imaging system according to any one of Techniques 1 to 5,
in which the compressed image acquired in the first mode is stored in a memory device in association with information regarding a γ correction value for the compressed image.

This imaging system helps apply γ correction to the compressed image before generating a hyperspectral image.

### Technique 7

The imaging system according to any one of Techniques 1 to 6,
in which, in the first mode, the control circuit sets the exposure time based on a highest pixel value among pixel values corresponding to respective pixels included in the compressed image.

This imaging system allows the exposure time suitable for a compressed image for generating a hyperspectral image to be set.

### Technique 8

The imaging system according to Technique 2, in which
in the second mode, the compressed image is acquired using a different γ correction value from that for the compressed image acquired in the first mode,
the compressed image acquired in the second mode is sent to at least one of a processing circuit processing circuit or a memory device, the processing circuit outputs the compressed image acquired in the second mode as the observation image or generates the observation image based on the compressed image acquired in the second mode, and
the memory device stores the compressed image acquired in the second mode.

This imaging system can generate an observation image suitable for user viewing immediately after the compressed image is acquired or as necessary.

### Technique 9

The imaging system according to Technique 2 or 8,
in which, in the second mode, the control circuit sets at least one of the exposure time or an ISO sensitivity based on an average pixel value of pixel values corresponding to respective pixels included in the compressed image.

This imaging system allows the exposure time suitable for a compressed image for generating an observation image to be set.

### Technique 10

The imaging system according to Technique 2, 8, or 9,
in which the control circuit deletes the compressed image acquired in the second mode without storing the compressed image acquired in the second mode in a memory device.

In this imaging system, the storage capacity of the memory device can be saved.

### Technique 11

A method performed by an imaging system including a camera that acquires a compressed image in which information regarding four or more wavelength bands is compressed,
the method including
setting an exposure time of the camera in an automatic exposure mode to acquire the compressed image using the camera, and
in which the automatic exposure mode includes a first mode for a case where four or more images corresponding to four or more respective wavelength bands are to be generated based on the compressed image.

This method allows parameters, such as exposure time, gamma correction value, or both, to be set appropriately to acquire, process, or acquire and process a compressed image. As a result, a compressed image for generating a more accurate hyperspectral image can be acquired.

### Technique 12

An information processing method including:
acquiring a compressed image in which information regarding four or more wavelength bands is compressed,
acquiring information regarding a γ correction value associated with the compressed image,
determining, based on the information, whether or not the γ correction value for the compressed image satisfies a predetermined condition,
in a case where it is determined that the γ correction value for the compressed image does not satisfy the predetermined condition, changing the γ correction value for the compressed image to satisfy the predetermined condition, and generating the four or more images based on the compressed image obtained using the changed γ correction value, and the predetermined condition includes at least one of a γ correction value greater than or equal to 0.9 and less than or equal to 1.1, or a γ correction value of 1.0.

Using this information processing method, a more accurate hyperspectral image can be generated.

The technology according to the present disclosure is useful, for example, in cameras and measurement devices that acquire multi-wavelength or high-resolution images. The technology according to the present disclosure can be applied to sensing for biological, medical, and cosmetic applications, inspection systems for foreign matter and pesticide residues in food, remote sensing systems, and vehicle-mounted sensing systems, for example.

What is claimed is:

1. An imaging system comprising:
a camera that acquires a compressed image in which information regarding four or more wavelength bands is compressed; and
a control circuit that sets an exposure time of the camera in an automatic exposure mode to acquire the compressed image using the camera,
wherein the automatic exposure mode includes a first mode for a case where four or more images corresponding to four or more respective wavelength bands are to be generated based on the compressed image.

2. The imaging system according to claim 1,
wherein the automatic exposure mode further includes a second mode for a case where the compressed image is to be output as an observation image or a case where an observation image including information regarding three or fewer wavelength bands is to be generated based on the compressed image.

3. The imaging system according to claim 1,
wherein the compressed image acquired in the first mode is sent to a processing circuit, and
the processing circuit generates the four or more images based on the compressed image having a γ correction value greater than or equal to 0.9 and less than or equal to 1.1.

4. The imaging system according to claim 3, wherein
the processing circuit
determines whether or not the γ correction value for the compressed image acquired in the first mode and sent satisfies a predetermined condition,
in a case where it is determined that the γ correction value for the compressed image does not satisfy the condition, changes the γ correction value for the compressed image to satisfy the predetermined condition, and
generates the four or more images based on the compressed image obtained using the changed γ correction value, and
the predetermined condition includes at least one of a γ correction value greater than or equal to 0.9 and less than or equal to 1.1, or a γ correction value of 1.0.

5. The imaging system according to claim 1, wherein
the compressed image acquired in the first mode is acquired using a γ correction value greater than or equal to 0.9 and less than or equal to 1.1 and is sent to a memory device.

6. The imaging system according to claim 1,
wherein the compressed image acquired in the first mode is stored in a memory device in association with information regarding a γ correction value for the compressed image.

7. The imaging system according to claim 1,
wherein, in the first mode, the control circuit sets the exposure time based on a highest pixel value among pixel values corresponding to respective pixels included in the compressed image.

8. The imaging system according to claim 2, wherein
in the second mode, the compressed image is acquired using a different γ correction value from that for the compressed image acquired in the first mode,
the compressed image acquired in the second mode is sent to at least one of a processing circuit processing circuit or a memory device,
the processing circuit outputs the compressed image acquired in the second mode as the observation image or generates the observation image based on the compressed image acquired in the second mode, and
the memory device stores the compressed image acquired in the second mode.

9. The imaging system according to claim 2,
wherein, in the second mode, the control circuit sets at least one of the exposure time or an ISO sensitivity based on an average pixel value of pixel values corresponding to respective pixels included in the compressed image.

10. The imaging system according to claim 2,
wherein the control circuit deletes the compressed image acquired in the second mode without storing the compressed image acquired in the second mode in a memory device.

11. A method performed by an imaging system including a camera that acquires a compressed image in which information regarding four or more wavelength bands is compressed, the method comprising:
setting an exposure time of the camera in an automatic exposure mode to acquire the compressed image using the camera,
wherein the automatic exposure mode includes a first mode for a case where four or more images corresponding to four or more respective wavelength bands are to be generated based on the compressed image.
